(19) United States
(12) Patent Application Publication
(10) Pub. No.: US 2011/0013960 A1
(43) Pub. Date: Jan. 20, 2011

(54) DOCUMENT FEEDER AND IMAGE-FORMING APPARATUS

(75) Inventor: Takuya ITO, Ebina-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/830,736

(22) Filed: Jul. 6, 2010

(30) Foreign Application Priority Data
Jul. 15, 2009 (JP) 2009-166341

(51) Int. Cl. G03G 15/00

(52) U.S. Cl. 399/371

(57) ABSTRACT

A document feeder includes: a document tray on which documents to be scanned are placed; a discharge tray onto which a scanned document is discharged; and a conveyance unit that conveys a document from the document tray to the discharge tray such that the document is caused to pass through an image-scanning position, the conveyance unit having: a first conveyance roll that supplies a document to the image-scanning position; a second conveyance roll that conveys a document that has passed the image-scanning position further downstream; a third conveyance roll that discharges a scanned document to the discharge tray; a driving force transmission mechanism that causes the first conveyance roll, the second conveyance roll, and the third conveyance roll to rotate relative to each other; and a document feeding operation member provided at a rotational shaft of the third conveyance roll, that is manually operated to rotate the rotational shaft.

### CROSS-REFERENCE TO RELATED APPLICATIONS

This application is based on and claims priority under 35 USC 119 from Japanese Patent Application No. 2009-166341 filed on Jul. 15, 2009.

### BACKGROUND

### Technical Field

The present invention relates to a document feeder and an image-forming apparatus.

### SUMMARY

An aspect of the present invention provides a document feeder including: a document tray on which documents to be scanned are placed; a discharge tray onto which a scanned document is discharged; and a conveyance unit that conveys a document from the document tray to the discharge tray such that the document is caused to pass through an image-scanning position, the conveyance unit having: a first conveyance roll provided upstream in a document conveyance direction relative to the image-scanning position, that supplies a document to the image-scanning position; a second conveyance roll provided downstream in the document conveyance direction relative to the image-scanning position, that conveys a document that has passed the image-scanning position further downstream; a third conveyance roll provided downstream in the document conveyance direction relative to the second conveyance roll, that discharges a scanned document to the discharge tray; a driving force transmission mechanism that causes the first conveyance roll, the second conveyance roll, and the third conveyance roll to rotate relative to each other; and a document feeding operation member provided at a rotational shaft of the third conveyance roll, that is manually operated to rotate the rotational shaft.

### BRIEF DESCRIPTION OF THE DRAWINGS

Exemplary embodiments of the present invention will now be described in detail below with reference to the following figures, wherein:

FIG. 1 is a schematic view showing a configuration of an image-forming apparatus according to the present invention;

FIG. 2 is a sectional side view of a main part of a document feeder according to the present invention;

FIG. 3 is a plain view of a main part of a document feeder according to the present invention; and

FIG. 4 is a sectional side view of a main part of a document feeder according to a comparison example.

### DETAILED DESCRIPTION

A document feeder and an image-forming apparatus according to the present invention will be described below with reference to the drawings.

### [Configuration of Image-Forming Apparatus]

A configuration of an image-forming apparatus will now be described.

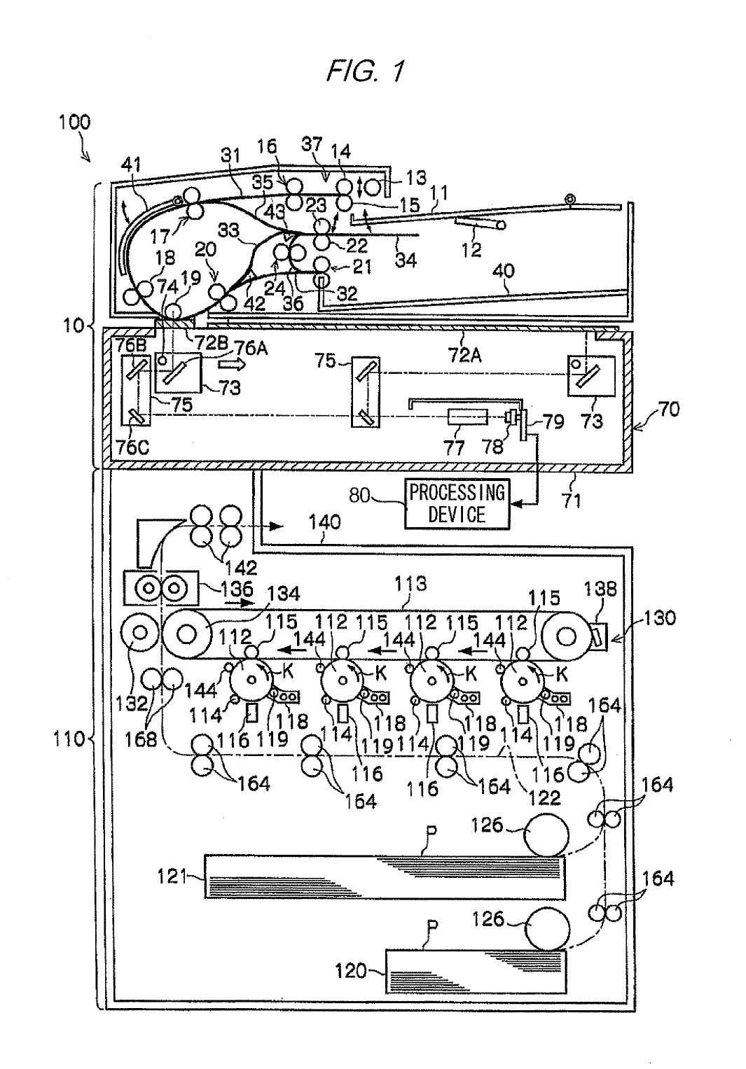

FIG. 1 is a schematic view showing a configuration of an image-forming apparatus according to the present invention.

As shown in the drawing, image-forming apparatus 100 includes image-scanning device 10 and image-forming device 110.

Image-scanning device 10 is an upper part of image-forming apparatus 100. Image-scanning device 10 scans a document, and converts an image of the scanned document into an image signal.

Image-forming device 110 includes a lower section of image-forming apparatus 100, and forms an image on recording media P in accordance with a signal converted by image-scanning apparatus 10.

### [Configuration of Image-Forming Device]

A configuration of image-forming device 110 will now be described.

In the lower part of image-forming device 110 there are included recording-media supply units 120 and 121 (hereinafter, simply “supply unit(s)”). Sizes of media stored differ between the respective supply units. For example, supply unit 120 may store media P of size B5, while supply unit 121 may store media P of size B4.

Supply roll 126 is located immediately above an end (the right end in FIG. 1) each of supply units 120 and 121. Supply roll 126 rotates while contacting an upper end of recording media P, thereby sending recording media P from supply unit 120 or 121.

In image-forming device 110, there is provided conveyance path 122 that extends from an end each of supply units 120 and 121 to an upper part of image-forming device 110 in an S-shaped curvature. Along conveyance path 122, there are provided plural (e.g., six) sets of conveyance rolls 164 and one pair of registration rolls 168, which hold and convey recording media P. Conveyance rolls 164 are provided upstream of registration rolls 168 along a path of conveyance of recording media.

Image-forming unit 130 is provided above supply unit 121, which forms an image on recording media P. Recording media P stored in supply unit 120 or 121 is fed by feed roll 126, and conveyed to image-forming unit 130 by conveyance rolls 164 and registration roll 168 through conveyance path 122.

Image-forming unit 130 forms a color image on recording media P conveyed from supply unit 120 or 121, using the colors cyan, magenta, yellow, and black. To that end, in image-forming unit 130, four photoreceptor drums 112 are arranged so that they can rotate in tandem. Photoreceptor drums 112 are caused to rotate in a direction of arrow K by a drive part (not shown).

Below the lower left of each photoreceptor drum 112, charging roller 114 is provided so that it contacts photoreceptor drum 112. Charging roller 114 charges a surface of photoreceptor drum 112 to a predetermined electric potential. After being charged, each photoreceptor drum 112 is exposed to light irradiated from exposing head 116 provided below each photoreceptor drum 112. As a result, a latent image corresponding to an image signal converted by image-scanning apparatus 10 is formed on a surface of each photoreceptor drum 112.

Developing roller 119 of developing unit 118 for each color holds toners of a particular color with a predetermined electrical charge. A latent image formed on a surface of each photoreceptor drum 112 is developed to a toner image of a particular color by applying a developing bias to developing roller 119.

The toner image of a particular color formed on each of photoreceptor drums 112 is transferred onto intermediate transfer belt 113, which is provided above photoreceptor drums 112, by first transfer roller 115; as a result, a full-color toner image is formed on intermediate transfer belt 113.

Recording media P sent from supply unit 120 or 121 and conveyed by conveyance rolls 164 is sent to a nip section formed by second transfer roller 132 and intermediate transfer roller 134, at a predetermined time by registration roller 168, and the full-color toner image is transferred to recording media P.

Recording media P onto which the full-color toner image has been transferred is conveyed to fixing unit 136. Fixing unit 136 fixes the toner image on recording media P using heat and pressure, and media P is then discharged under rotation of discharge roller 142 onto discharge tray 140.

When transfer of the toner image as described above is carried out, not all of the toner forming the image is transferred to intermediate transfer belt 113 or recording media P; rather, a part of the toner remains on photoreceptor drums 112 and intermediate transfer belt 113 as residual toner. Residual toner remaining on photoreceptor drums 112 is removed by cleaning rolls 144, while that remaining on intermediate transfer belt 113 is removed by cleaning device 138.

### [Configuration of Image-Scanning Device]

A configuration of image-scanning device 10 will now be described.

Image-scanning device 10 serves as a document feeder that feeds documents to be scanned. Image-scanning device 10 scans the documents fed by the document feeder. Specifically, a function of the document feeder is realized by document tray 11, conveyance unit 37, and discharge tray 40. Scanning of a document and processing of an image signal of the scanned document are carried out by scanning unit 70 and processing device 80.

Image-scanning apparatus 10 includes document tray 11 that acts as a platen on which documents of different sizes are placed. Namely, on document tray 11, there are placed documents of sizes that differ in at least one of a document length, extending in document feeding direction A, and a document width, extending in a direction perpendicular to document feeding direction A. Tray lifter 12 moves document tray 11 up and down.

Image-scanning apparatus 10 also includes conveyance unit 37 that separates documents placed on document tray 11 and conveys the documents one by one to discharge tray 40, which tray is an example of a discharge board.

Conveyance unit 37 includes supply roll 13 that sends documents from document tray 11 elevated by tray lifter 12, feed roll 14 that conveys the documents sent downstream by supply roll 13, and separating roll 15 that separates the documents sent by supply roll 13.

Also, conveyance unit 37 includes first conveyance path 31 to which a document sent from document tray 11 is first conveyed. First conveyance path 31 includes take-away rolls 16 that convey a separated document to rolls located downstream, pre-registration rolls 17 that convey the document to rolls located further downstream, whereby a loop is formed in the document along the conveyance path, registration rolls 18 that from a state of suspension restart rotation to provide the document to scanning unit 70 while carrying out registration adjustments, platen roll 19 that assists in conveyance of a document being scanned, and out-rolls 20 that convey a scanned document further downstream.

Also, first conveyance path 31 includes baffle 41 that moves around the point of support depending on whether a document conveyed has been bent to form a loop.

In the downstream side of out-rolls 20, second conveyance path 32 and third conveyance path 33 are provided. At the fork of second conveyance path 32 and third conveyance path 33, conveyance path switching gate 42 is provided, which switches a conveyance path between second conveyance path 32 and third conveyance path 33.

In the downstream side of second conveyance path 32 there is provided a first discharging roll 21 that discharges a conveyed document onto discharge tray 40, which tray acts as a discharge unit onto which a scanned document is discharged.

In the downstream side of third conveyance path 33, fourth conveyance path 34 is provided, which enables switchback of a document that has passed third conveyance path 33.

In fourth conveyance path 34, inverter roll 22 and inverter pinch roll 23 are provided, which act to switch back a document.

Fourth conveyance path 34 is connected to first conveyance path 31 via fifth conveyance path 35 that leads a document to first conveyance path 31 after the document has been switched back.

Fourth conveyance path 34 is also connected to sixth conveyance path 36 that discharges a document onto discharge tray 40 after the document has been switched back. Sixth conveyance path 36 includes second discharging rolls 24 that convey a document to be turned over and discharged to first discharging roll 21, and exit switching gate 43 that switches a conveyance path between fifth conveyance path 35 and sixth conveyance path 36.

Supply roll 13 is, at a standby time, lifted up and kept at a standby position, and when a document is conveyed, lowered to a nip position (document conveyance position) so that the roll conveys the top document placed on document tray 11.

Supply roll 13 and feed roll 14 convey a document upon engagement of feed clutches (not shown). Pre-registration rolls 17 cause an edge of a document to contact registration roll 18, rotation of which is at that time suspended, so as to cause the document to form a loop. When a loop is formed, registration rolls 18 begin to rotate to return an end of a document that has been caught between registration rolls 18 to a nip position. After the loop is formed, baffle 41 moves outward around its fulcrum so as not to prevent formation of the loop.

Take-away rolls 16 and pre-registration rolls 17 maintain the loop in the document that is being scanned. Upon formation of the document loop, a timing of scanning is adjusted. Also, occurrence of skews resulting from conveyance of a document to be scanned is prevented; namely, an alignment capability is enhanced. Upon commencement of a scan of a document, registration rolls 18 start to rotate, and the document is pressed by platen roll 19 against second platen glass 72B, and the under-surface of the document is scanned whereby image data is generated.

Conveyance path switching gate 42, after either single or simultaneous double- sided scanning of a document is complete, is switched so that the document that has moved through out-rolls 20 is led to second conveyance path 32, and discharged onto discharge tray 40. If a document is to be subjected to simultaneous double-sided scanning, conveyance path switching gate 42 is switched so that the document is led to third conveyance path 33, as a result of which the document is turned over. Inverter pinch roll 23, when a document is subjected to simultaneous double-sided scanning, is retracted so that a nip is opened, when a feed clutch (not shown) is in an “off” state, as a result of which the document is led to an inverter path (fourth conveyance path 34). Thereafter, inverter pinch roll 23 is moved to a nip position so that a document to be inverted by inverter roll 22 is led to pre-registration rolls 17. Further, inverter pinch roll 23 conveys a document to be inverted and discharges the document to second discharging rolls 24 of sixth conveyance path 36.

Scanning unit 70 is provided in the lower part of image-scanning apparatus 10. Scanning unit 70 scans a document conveyed by conveyance unit 37. Device frame 71 that constitutes a housing for scanning unit 70 includes first platen glass 72A on which a document to be scanned is statically placed, and second platen glass 72B through which light is transmitted for scanning of a document being conveyed.

Scanning unit 70 also includes full-rate carriage 73 that stands by under second platen glass 72B, and performs scanning over the entire first platen glass 72A, half-rate carriage 75 that provides light obtained from full-rate carriage 73 to an imaging unit. Full-rate carriage 73 includes illuminating lamp 74 that irradiates light to a document, and first mirror 76A that receives light reflected by a document. Half-rate carriage 75 includes second mirror 76B and third mirror 76C that leads light reflected by first mirror 76A to an imaging unit.

Scanning unit 70 also includes imaging lens 77 that reduces an optical image reflected by third mirror 76C, CCD (Charge Coupled Device) image sensor 78 that carries out photoelectric conversion of an optical image formed by imaging lens 77, and drive plate 79 on which CCD image sensor 78 is provided. An image signal obtained by CCD image sensor 78 is sent to processing device 80 via drive plate 79. Processing device 80 sends the image signal to exposing head 116.

In a case where a document that is placed on first platen glass 72A is scanned, full-rate carriage 73 and half-rate carriage 75 are caused to move in a scanning direction (in a direction of the arrow). A ratio of distances of movement of full-rate carriage 73 and half-rate carriage 75 is two to one. Namely, when the two carriages are caused to move, illuminating lamp 74 of full-rate carriage 73 irradiates light to a surface of the document to be scanned, and light reflected by the document is led to imaging lens 77 via first mirror 76A, second mirror 76B, and third mirror 76C. The light led to imaging lens 77 is led to CCD image sensor 78 to form an image on a light-receiving surface of the CCD image sensor. CCD image sensor 78 is a one-dimensional sensor that processes one line of the document at a time. When scanning of one line extending in the main scanning direction, is complete, full-rate carriage 73 is caused to move in a direction perpendicular to the main scanning direction (the vertical scanning direction), and a next line is scanned. Thus scanning of the entire document is carried out.

Second platen glass 72B is, for example, a long transparent glass plate. A document conveyed by conveyance unit 37 passes over second platen glass 72B. When a document passes over second platen glass 72B, full-rate carriage 73 and half-rate carriage 75 halt at a position indicated by a solid line in FIG. 1. If a document passes platen roll 19 of conveyance unit 37, and one line of the document is subjected to light irradiated from illuminating lamp 74, the reflected light is led to imaging lens 77 via first mirror 76A, second mirror 76B, and third mirror 76C to form an image. The image is read by CCD image sensor 78, which is a one-dimensional sensor. After the image for one line, which extends in the main scanning direction, is simultaneously processed by CCD image sensor 78, the next line, which extends in the main scanning direction, of the document, which is being conveyed by conveyance unit 37, is scanned. After the entire document passes a scanning position on second platen glass 72B, scanning of the document in the vertical scanning direction is completed.

### [Configuration of Main Part of Document Feeder]

A configuration of a main part of a document feeder included in image-scanning device 10 will now be described.

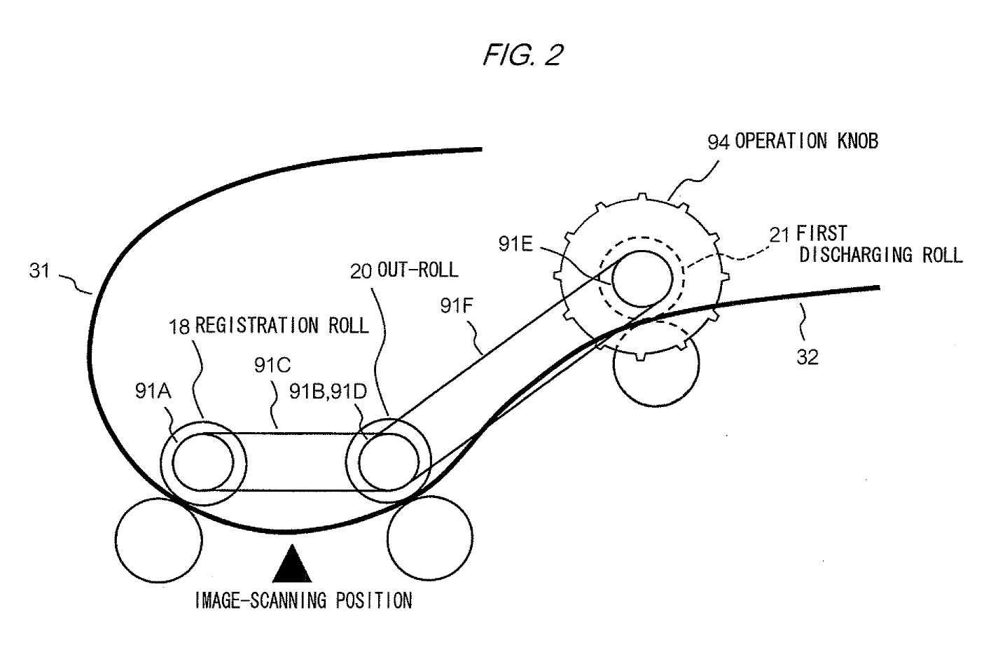

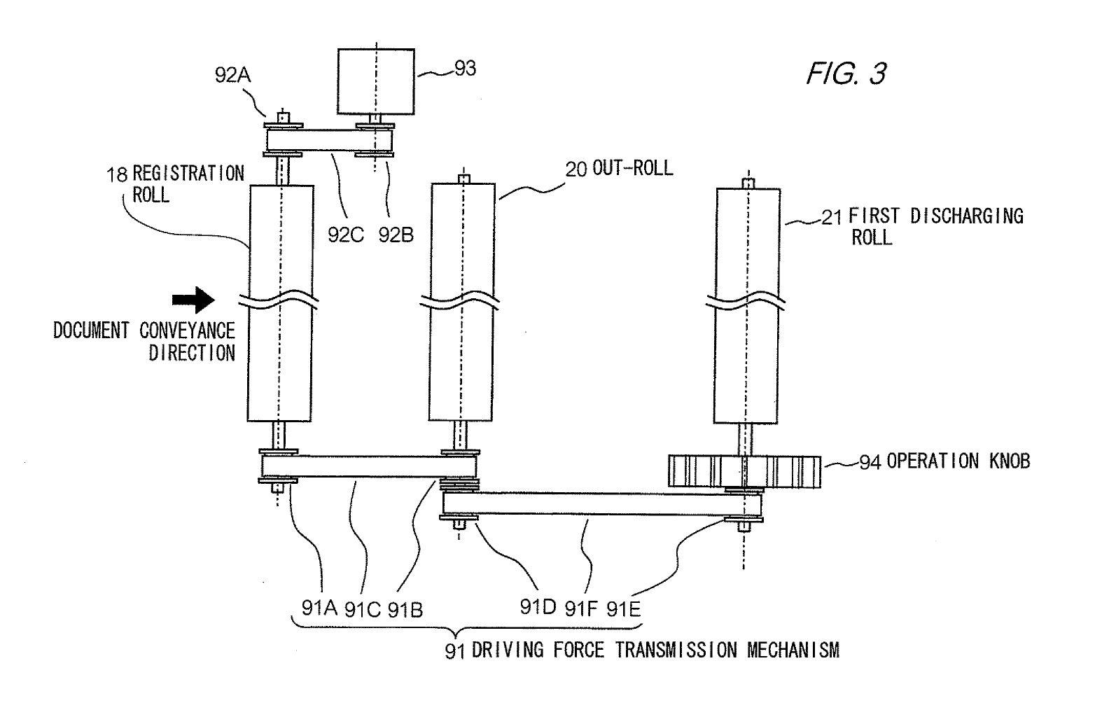

FIG. 2 is a sectional side view of a main part of a document feeder according to the present invention. FIG. 3 is a plain view of the main part.

As shown in FIG. 2, in conveyance unit 37 of image-scanning device 10, which is a component of a document feeder, first conveyance path 31 is formed so that a document sent from document tray 11 is rotated. Along first conveyance path 31, there are provided registration rolls 18 and out-rolls 20.

Registration rolls 18 provide a document to scanning unit 70 while carrying out registration adjustments. Registration rolls 18 correspond to first conveyance rolls, which are provided upstream in the document conveyance direction relative to an image scanning position for scanning unit 70, and provide a document to the image scanning position.

Out-rolls 20 convey a document scanned by scanning unit 70 further downstream, and these out-rolls correspond to second conveyance rolls, which are provided downstream in the document conveyance direction relative to an image scanning position for scanning unit 70, and rotate to convey further downstream a document that has passed the image scanning position.

In the downstream side of out-rolls 20, second conveyance path 32 is formed. Along second conveyance path 32, there is provided first discharging rolls 21.

First discharging rolls 21 discharge a document onto discharge tray 40. First discharging rolls 21 correspond to third conveyance rolls, which are provided downstream in the document conveyance direction relative to out-rolls 20, and discharge a scanned document onto discharge tray 40.

First discharging rolls 21 are arranged so that their rotational shafts are positioned above the rotational shafts of registration rolls 18 and out-rolls 20 when image-forming apparatus 100 is installed. This is because registration rolls 18 and out-rolls 20 are provided at a lower position (a position closer to scanning unit 70) since they have to convey a document close to scanning unit 70 at an image scanning position, and first discharging rolls 21 are provided at a higher position since they have to discharge documents so that the documents are stacked on discharge tray 40.

A rotational shaft of registration roll 18 and a rotational shaft of out-roll 20 are coupled by a driving force transmission mechanism including pulleys 91A and 92B and belt 91C. The rotational shaft of out-roll 20 and a rotational shaft of first discharging roll 21 are coupled by a driving force transmission mechanism including pulleys 91D and 91E and belt 91F. Namely, the rotational shafts of registration roll 18, out-roll 20, and first discharging roll 21 are coupled by driving force transmission mechanism 91 including pulleys 91A, 91B, 91D, and 91E, and belts 91C and 91F. Accordingly, registration roll 18, out-roll 20, and first discharging roll 21 are caused to rotate together by a driving force transmitted by driving force transmission mechanism 91.

An end of the rotational shaft of registration roll 18, at which pulley 91A is not provided, is coupled with driving source 93 such as an electric motor via a driving force transmission mechanism including pulleys 92A and 92B and belt 92C.

At the rotational shaft of first discharging roll 21, operation knob 94 is provided, which is an example of a document feeding operation member.

Operation knob 94 is used to manually rotate the rotational shaft of first discharging roll 21, which includes the rotational shaft and a disk-shaped member. At the outer circumferential surface of the disk-shaped member, protrusions are formed at regular intervals. Alternatively, knurling may be applied to the outer circumferential surface of the disk-shaped member.

Operation knob 94 and pulley 91E, which is provided at the rotational shaft of first discharging roll 21, may be formed as a single unit, for example, by molding a resin material. Alternatively, operation knob 94 and pulley 91E may be formed as a single unit, using other known methods. Obviously, operation knob 94 and pulley 91E may be formed as separate units.

### [Operation of Document Feeder]

In image-scanning device 10 having conveyance unit 37, which has the foregoing configuration, when the image-scanning device is jammed, an outer cover (not shown), which covers conveyance unit 37, is opened so that a document jamming the image-scanning device is removed.

Specifically, when the outer cover is opened, components such as supply roll 13 and feed roll 14, which are provided above first conveyance path 31, are moved together with the outer cover. After the outer cover is opened, a document, which is stuck in conveyance unit 37 is exposed before the document is turned around. After the document is exposed, the document can be removed from first conveyance path 31.

If the document has been turned around in conveyance unit 37, the document would be located below registration roll 18 and out-roll 20. In this situation, even if the outer cover is opened, the document cannot be removed.

However, in conveyance unit 37 having the foregoing configuration, operation knob 94 is provided at a rotational shaft of first discharging roll 21. An outer circumferential surface of operation knob 94, which faces upward, would be exposed, if the outer cover is opened.

If operation knob 94 is exposed, and manually rotated, a rotational shaft of first discharging roll 21 is caused to rotate accordingly. If the rotational shaft of first discharging roll 21 is caused to rotate, registration roll 18 and out-roll 20 are caused to rotate together by a driving force transmitted by driving force transmission mechanism 91.

Accordingly, by manually rotating operation knob 94, it is possible to discharge a document, which is stuck in conveyance unit 37 after the document is turned around, to first conveyance path 31. The document discharged to the first conveyance path 31 can be removed, as described above.

As described in the foregoing, according to the present exemplary embodiment, by manually rotating operation knob 94, registration roll 18, out-roll 20, and first discharging roll 21 are caused to rotate together by a driving force transmitted by driving force transmission mechanism 91. Accordingly, in a case where a document is stuck in conveyance unit 37, a user is able to remove the document by manually rotating operation knob 94. In addition, since operation knob 94 is provided at a rotational shaft of first discharging roll 21, complication of the document feeder is avoided.

The merit of avoiding complication will now be described with reference to a comparison example.

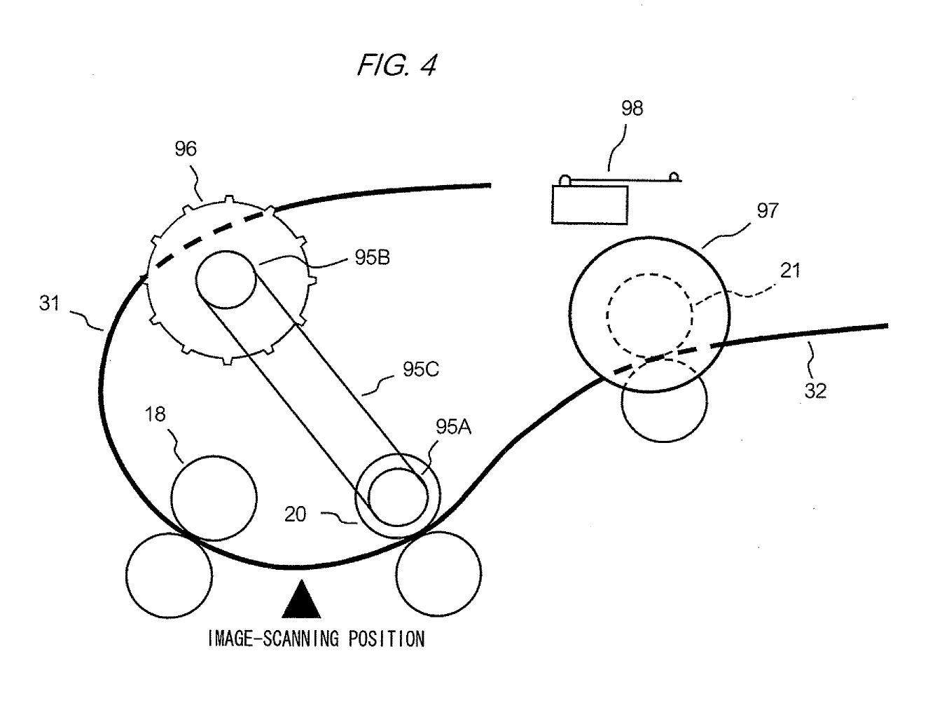

FIG. 4 is a sectional side view of a main part of a document feeder according to the comparison example.

In the document feeder of the drawing, operation knob 96 is provided near an outer cover so that a part of the operation knob is exposed when the outer cover is open. Also, a driving force transmission mechanism is provided that includes pulleys 95A and 95B, and belt 95C, and transmits rotation of operation knob 96 to a rotational shaft of out-roll 20. Accordingly, by operating operation knob 96 manually, a document stuck in conveyance unit 37 can be discharged to first conveyance path 31, where a user is able to remove the document. However, a problem exists in that the driving force transmission mechanism including pulleys 95A and 95B, and belt 95C is required to transmit a driving force of operation knob 96 to a rotational shaft of out-roll 20.

In contrast to the comparison example, in the exemplary embodiment described above, operation knob 94 is provided at a rotational shaft of first discharging roll 21. Accordingly, the driving force transmission mechanism including pulleys 95A and 95B, and belt 95C is not necessary, and therefore, a number of parts is reduced.

If the exemplary embodiment described above is provided with damper 97, which stabilizes rotation of first discharging roll 21 because of a flywheel effect, and micro switch 98, which detects opening and closing of an outer cover, as in the case of the comparison example shown in FIG. 4, components may be provided in a side of the rolls in which driving force transmission mechanism 91 is not provided (namely, a side in which driving source 93 is provided), so that a space in which operation knob 94 is provided can be secured.

In the exemplary embodiment described above, since operation knob 94 is provided at a rotational shaft of first discharging roll 21, as compared with a case in which operation knob 94 is provided at a rotational shaft of registration roll 18 or out-roll 20, the diameter of the operation knob can be increased. This is because the rotational shaft of first discharging roll 21 is arranged so that it is positioned above the rotational shafts of registration roll 18 and out-roll 20 when image-forming apparatus 100 is installed.

However, it is not always necessary to provide operation knob 94 at a rotational shaft of first discharging roll 21. If a sufficient space is secured, operation knob 94 may be provided at a rotational shaft of registration roll 18 or out-roll 20. Even in that case, it is possible to facilitate removal of a document that is stuck, while avoiding an increase in a number of parts as compared with the comparison example described above.

In avoiding an increase in a number of parts, it is effective to fabricate operation knob 94 and pulley 91E integrally as a single unit.

The foregoing description of the exemplary embodiments of the present invention has been provided for the purposes of illustration and description. It is not intended to be exhaustive or to limit the invention to the precise forms disclosed. It will be apparent to those skilled in the art that many modifications and variations are possible. The embodiments were chosen and described in order to explain best the principles of the invention and its practical applications, thereby enabling others skilled in the art to understand the invention in view of various embodiments and a variety of modifications as may be best suited to a particular use contemplated. It is intended that the scope of the invention be defined by the following claims and their equivalents.

What is claimed is:

1. A document feeder comprising:
a document tray on which documents to be scanned are placed;
a discharge tray onto which a scanned document is discharged; and
a conveyance unit that conveys a document from the document tray to the discharge tray such that the document is caused to pass through an image-scanning position, the conveyance unit having:
a first conveyance roll provided upstream in a document conveyance direction relative to the image-scanning position, that supplies a document to the image-scanning position;
a second conveyance roll provided downstream in the document conveyance direction relative to the image-scanning position, that conveys a document that has passed the image-scanning position further downstream;
a third conveyance roll provided downstream in the document conveyance direction relative to the second conveyance roll, that discharges a scanned document to the discharge tray;
a driving force transmission mechanism that causes the first conveyance roll, the second conveyance roll, and the third conveyance roll to rotate relative to each other; and
a document feeding operation member provided at a rotational shaft of the third conveyance roll, that is manually operated to rotate the rotational shaft.

2. The document feeder according to claim 1, wherein the third conveyance roll is arranged such that when the document feeder is installed the rotational shaft of the third conveyance roll is positioned above the rotational shafts of the first conveyance roll and the second conveyance roll.

3. The document feeder according to claim 1, wherein the document feeding operation member and a pulley for a belt constituting the driving force transmission mechanism are formed as a single unit.

4. The document feeder according to claim 2, wherein the document feeding operation member and a pulley for a belt constituting the driving force transmission mechanism are formed as a single unit.

5. An image-forming apparatus comprising:
an image-scanning device that acts as a document feeder to convey a document to be scanned, and that scans the conveyed document; and
an image-forming device that forms an image on recording media in accordance with an image scanned by the image-scanning device, wherein the document feeder includes:
a document tray on which documents to be scanned are placed;
a discharge tray onto which a scanned document is discharged; and
a conveyance unit that conveys a document from the document tray to the discharge tray such that the document is caused to pass through an image-scanning position, the conveyance unit including:
a first conveyance roll provided upstream in a document conveyance direction relative to the image-scanning position, that supplies a document to the image-scanning position;
a second conveyance roll provided downstream in the document conveyance direction relative to the image-scanning position, that conveys a document that has passed the image-scanning position further downstream;
a third conveyance roll provided downstream in the document conveyance direction relative to the second conveyance roll, that discharges a scanned document to the discharge tray;
a driving force transmission mechanism that causes the first conveyance roll, the second conveyance roll, and the third conveyance roll to rotate relative to each other; and
a document feeding operation member provided at a rotational shaft of the third conveyance roll, that is manually operated to rotate the rotational shaft.
